(19) United States
(12) Patent Application Publication
(10) Pub. No.: US 2013/0239825 A1
(43) Pub. Date: Sep. 19, 2013

(54) ROTARY HAY WEDGE FOR ROUND BALERS

(71) Applicant: FORAGE INNOVATIONS B.V., MAASSLUIS (NL)

(72) Inventors: David Wayne JAHRAUS, PELLA, IA (US); Jerry Eugene BANDSTRA, PELLA, IA (US); James S. WILLIAMS, PELLA, IA (US); Henry W. VAN ROEKEL, LEIGHTON, IA (US)

(73) Assignee: Forage Innovations B.V., MAASSLUIS (NL)

(21) Appl. No.: 13/871,145

(22) Filed: Apr. 26, 2013

Related U.S. Application Data
(63) Continuation of application No. PCT/NL2011/000069, filed on Oct. 26, 2011.
(60) Provisional application No. 61/407,648, filed on Oct. 28, 2010.

(51) Int. Cl. A01F 15/07; A01F 15/08

(52) U.S. Cl. CPC A01F 15/071; A01F 15/085
USPC 100/5; 100/88

(57) ABSTRACT

A baler with a pickup and a baling chamber with an inlet, the bale forming chamber having a first and second side panel, a plurality rollers rotatably disposed respectively about parallel axes. A bale edge engaging member is rotatably attached to the frame about an axis of rotation substantially parallel to said axes of the rollers, the bale edge engaging member being disposed adjacent an inside portion of one of the side panels in overlapping arrangement with a bale being formed in the baling chamber at least at times when a bale is being formed. The bale edge engaging member is spaced from the inlet to the bale forming chamber so as to not impede material entering the bale forming chamber from a pickup. Alternate embodiments have the rotatable bale edge engaging member/disc on a fixed axis adjacent the baling chamber when the bale is almost completed.

### CROSS REFERENCE TO RELATED APPLICATIONS

This application is a continuation of PCT application number PCT/NL2011/000069 filed on 26 Oct. 2011, which claims priority from U.S. provisional application No. 61/407,648 filed on 29 October 2010. Both applications are hereby incorporated by reference in their entireties.

### BACKGROUND OF THE INVENTION

1. Field of the Invention

The present invention relates to a baler, in particular an agricultural baler for producing so-called round bales of crop material.

2. Description of the Related Art

Such a baler is known from for example U.S. Pat. No. 7,395,756, which shows a basic round baler of the type used in this art.

As a round bale is being created in a baler, some of the hay usually comes out between the belts and the sides of the baler. This is a problem because the extra strands of hay need to be removed before the hay can get to an area that it causes problems, or because the presence of these loose strands of hay produces a bale of an undesirable appearance, or the extra strands of hay can interfere with the application of net wrap around the bale when the bale is completed.

Patent Application Publication U.S. 2001/0047640 to Schaefer shows discs 26 located where the pickup feeds the hay into the baling chamber, the restrictor discs 26 and profiling members 31 in FIGS. 1 and 5 produce the resultant bale shape shown in Schaefer's FIG. 6.

U.S. Pat. No. 4,910,949 shows a hay wedge 35 that is located in a fixed position in that part of the bale chamber adjacent the inlet receiving hay from the pickup, a similar position as that of the discs 26 of Patent Application Publication U.S. 2001/0047640 to Schaefer.

U.S. Pat. No. 6,006,504 shows an inner surface 214 in FIG. 8, to contact a radially outer section of the end of a bale to create a small space or void for the net wrap material to enter the baling chamber. This device is in a fixed location within the bale chamber.

U.S. Pat. No. 6,477,824 shows a deflector 70 located in the inlet area of the baler to deflect material away from the sides of the baler to reduce material build-up.

EP 1516525 shows rollers 20 and 21 that have an axis of rotation transverse to the axes of rotation of the rollers that support the belts of the baler.

The known round balers do not produce desirable results. At least the known balers do not sufficiently avoid the presence of loose strands of hay which results in a bale having an undesirable appearance. Furthermore, the known balers do not in a desirable manner solve the problem in that the extra strands of hay interfere with the application of net wrap around the bale when the bale is completed.

### BRIEF SUMMARY OF THE INVENTION

Hence it is a first object of the present invention to provide a baler for producing round agricultural bales of crop material that yields better results. In particular it is an object of the present invention to provide a baler that solves the above-mentioned drawbacks of the prior art balers. A further object of the invention is to at least provide an alternative for the known balers.

Accordingly there is a need for an improvement that will reduce the amount of these extra strands of hay that are generated while a bale is being formed so that the completed bales do not have these extra strands of hay on the edges. Such an improvement reduces operational problems associated with build-up of loose strands of hay, and has also been found to improve the appearance of the finished bale. Further, when net wrap is being applied, it is desired to cause the outside edges of the bale to have a shape that allows the net wrap to go over the edges more easily. This additionally provides an improved aesthetic appearance to the bale.

These objects are achieved and these improvements are realized according to the invention by means of a baler with a baling chamber for receiving a material to be baled, the bale forming chamber comprising a left and right side panel, a plurality of members such has rollers rotatably disposed respectively about parallel axes, more than one of the parallel axes being fixed with respect to the side panels. A bale edge engaging member is rotatably attached to the frame about an axis of rotation substantially parallel to said axes of the rollers, the bale edge engaging member being disposed adjacent an inside portion of one of the side panels in overlapping arrangement with a bale being formed in the baling chamber at least at times when a bale is being formed. The baler has a material to be baled pickup to deliver material to be baled to an inlet of the bale forming chamber, and the bale edge engaging member is spaced from the inlet to the bale forming chamber so as to not impede material entering the bale forming chamber from the material to be baled pickup.

In one embodiment, a support arm is pivotally attached to the frame about an axis parallel to the axis of rotation of the bale edge engaging member and the bale edge engaging member is rotatably attached to the support arm. As a bale is being created, some of the hay is coming out between the belts and the sides of the baler. The rotary hay wedge has a disc that is forced into the gap between the outside belt and the side wall of the baler and is allowed to rotate with the bale. It pushes into the bale throughout formation, either tucking the edges in or knocking the strands of hay off before the hay can get to an area that it causes problems. It starts just above the lower drive roller and rotates up as the bale grows larger and larger.

When the bale is completed and net wrap is being applied, the outside edges of the bale will have a shape that allows the net wrap to go over the edges more easily. The rotary hay wedge is also pushing against the net on the edges trying to tuck it around the corners better. This gives an improved aesthetic appearance.

This type of device could be used on any round baler both current production and even possibly retro-fittable. The advantage that this provides is that it would eliminate potential down time from the problems that are caused by hay buildup.

The rotary disc could also serve as a guide for the outside belts to keep them from tracking outward as well. The rotary wedge is a larger diameter than the other rollers which helps prevent it from wrapping as easily with material. The idea behind it is that as the hay comes around from the lower tailgate area there is nothing preventing the hay from poking out between the outside belts and the side wall. This allows hay to stick out and then the next place it contacts is a through a wall drive roller such as for example used on balers produced by Vermeer Inc. (located in Pella, Iowa). When this contact occurs the hay can get knocked off and then end up as buildup in the front of the baler. Certain conditions are worse for this and can cause major issues. Having the rotating bale edge engaging member closer to the lower drive roller seems to be the best location for it.

### BRIEF DESCRIPTION OF THE DRAWINGS

Further advantages of the present invention will now be further exemplified in the following description of certain embodiments of a baler according to the invention with reference to the appended drawings, in which:

FIG. 1 shows a side view of a round baler with parts on one side omitted in order to show the rollers, belts and other parts of a round baler and to show a preferred embodiment of a rotatable bale edge engaging member/disc that is biased towards the outer edge of one side of a bale being formed in the baling chamber; FIG. 1 being before any material to be baled is in the baling chamber;

FIG. 2 is a side elevational view like FIG. 1, but showing a windrow of material to be baled being picked up by a pickup and delivered into the inlet of the baling chamber and showing how the rotatable bale edge engaging member/disc moves radially outwardly as the bale becomes bigger;

FIG. 3 is a side elevational view like FIGS. 1 and 2, but showing the bale being almost fully formed and how the rotatable bale edge engaging member/disc is still biased against the outer edge of one side of the bale;

FIG. 4 is an enlarged side elevational view of just that part of the preferred embodiment showing an arm pivotally attached to one side wall of the baler with a tension spring biasing the outward end of the arm that has the rotatable bale edge engaging member/disc on it towards the baling chamber;

FIG. 5 is a top view of the baling chamber showing a pair of the devices shown in FIG. 4 attached to the side walls of the baler;

FIG. 6 is an enlarged view of what is in the circle in FIG. 5, showing how the rotating bale edge engaging member tucks in the outside edges of the bale adjacent the sidewall of the bale;

FIG. 7 is an enlarged exploded view of the rotatable bale edge engaging member/disc and how the mounting arm is biasing the bale edge engaging member/disc towards the baling chamber;

FIG. 8 is an enlarged exploded view of the rotatable bale edge engaging member/disc much like FIG. 7, but with more parts exploded to show more details; and

FIG. 9 is an alternate embodiment showing the rotatable bale edge engaging member/disc in solid lines having a fixed axis of rotation that is parallel to the axes of rotation of the other rollers that the belts are trained around so that instead of following the bale from its infancy to its finished size, the rotatable bale edge engaging member/disc in solid lines only tucks in the outer edges of the bale during the final stages of the bale's formation;

FIG. 9 also shows another an alternate embodiment showing the rotatable bale edge engaging member/disc in dashed lines having a fixed axis of rotation that is parallel to the axes of rotation of the other rollers that the belts are trained around so that instead of following the bale from its infancy to its finished size, the rotatable bale edge engaging member/disc in dashed lines only tucks in the outer edges of the bale during the final stages of the bale's formation, the difference between the embodiment shown in solid and dashed lines being that the axis of rotation of the one in solid lines has the axis of rotation outside the baling chamber at all times and the embodiment shown in dashed lines being that the axis of rotation of the one in dashed lines has the axis of rotation inside the baling chamber only during the final stages of formation of the bale;

FIG. 10 is a top view of the baling chamber similar to FIG. 5, but showing bale edge engaging members arranged on a tube and projecting through the side walls of the baler;

FIG. 11 is a cross sectional view taken along lines 11-11 of FIG. 9 showing the baler belts trained over a roller that has bale edge engaging members attached through the sidewalls of the baling chamber;

FIG. 12A is a side elevational schematic view showing the preferred embodiment of FIGS. 1-8 with a bale edge engaging member shown in dashed lines in the position it would be in FIG. 2 and in a dark circle in the position it would be in FIG. 3 and furthermore showing netwrap entry point 70;

FIG. 12B is a side elevational schematic view showing the preferred embodiment of FIG. 9 with a bale edge engaging member and furthermore showing netwrap entry point 70;

FIG. 12C is a side elevational schematic view showing another preferred embodiment showing only two of several fixed position belt rollers with a bale edge engaging member disposed between them and furthermore showing netwrap entry point 170;

FIG. 12D is a side elevational schematic view showing still another preferred embodiment showing only two of several fixed position belt rollers with a bale edge engaging member disposed before them and furthermore showing netwrap entry point 270; and

FIG. 12E is a side elevational schematic view showing still another preferred embodiment of a baler rotating in the opposite direction of all of the other embodiments shown and with a bale edge engaging member disposed before any of the rollers (not shown) and furthermore showing netwrap entry point 370.

### DETAILED DESCRIPTION OF THE INVENTION

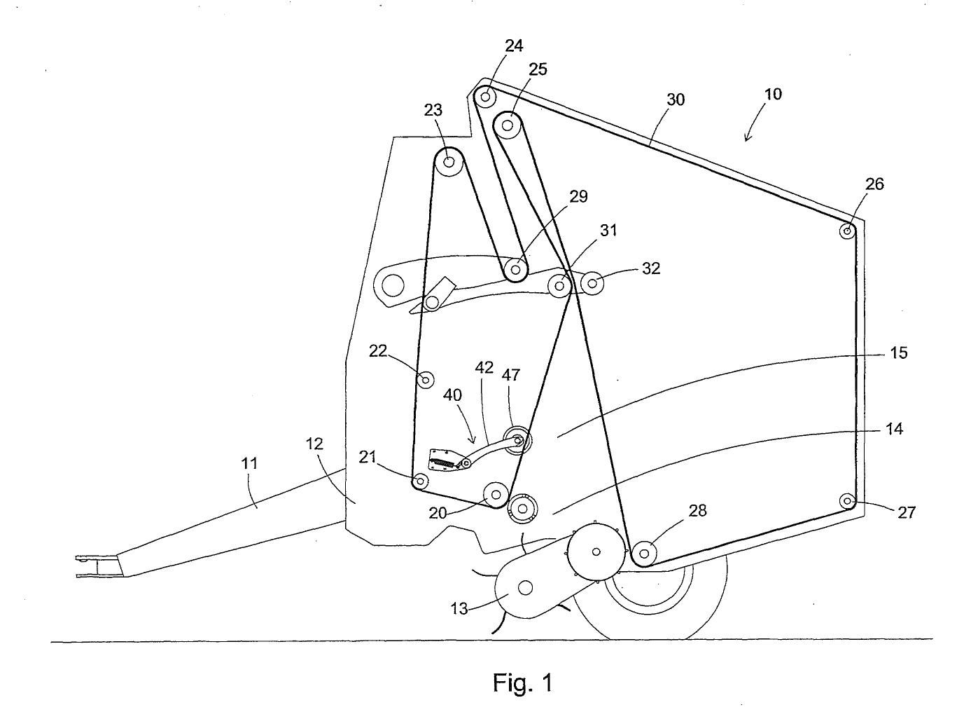

The following is a description of certain embodiments of the invention, given by way of example only and with reference to the drawings. FIG. 1 shows a baler 10 having a tongue 11 attached to a frame 12. A pickup 13 picks up hay or other material to be baled from the ground and delivers it to an inlet 14 of a baling chamber 15 of the baler 10. A plurality of rotatable members/rollers 20, 21, 22, 23, 24, 25, 26, 27, 28 are operatively rotatably attached to the frame 12 about fixed parallel substantially horizontal axes. Belts 30 are trained around the fixed rollers 20-28 and around moveable rollers 29, 31 and 32 which are disposed about moveable parallel axes which are also parallel to the axes of the fixed axis rollers 20-28. The operation of this baler is explained in detail in U.S. Pat. No. 7,395,756, which is hereby incorporated by reference in its entirety. It is to be understood, however, that the present invention is not limited to a belt type round baler but could be used with any round baler, for example including but not limited to round balers that use rotatable sprockets, slats and belts or chains like that shown in EP1 595 441, which is hereby incorporated by reference in its entirety, or just rollers and no belts or chains.

Attached to each sidewall is a rotatable disc/bale edge engaging member assembly 40 for tucking the edges of a bale in the baling chamber in or knocking the strands of hay off before the hay can get to an area that it causes problems.

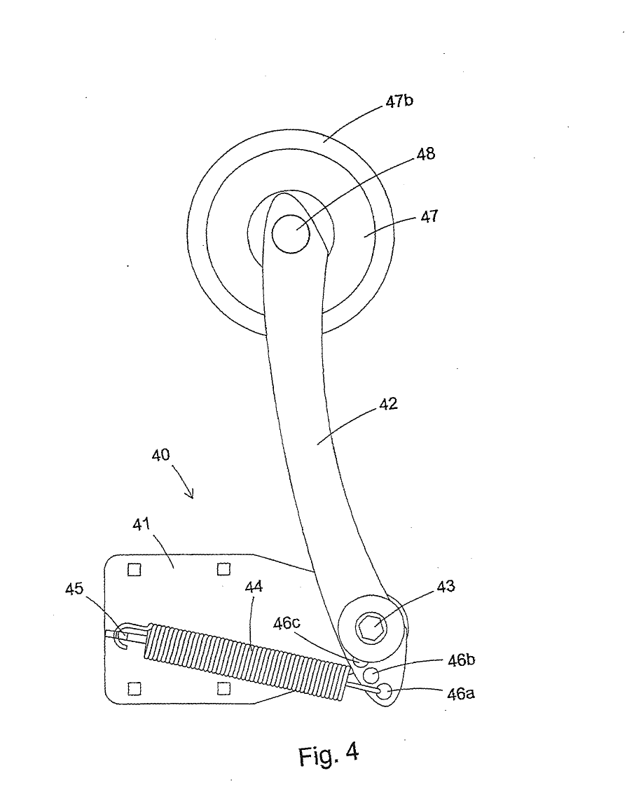

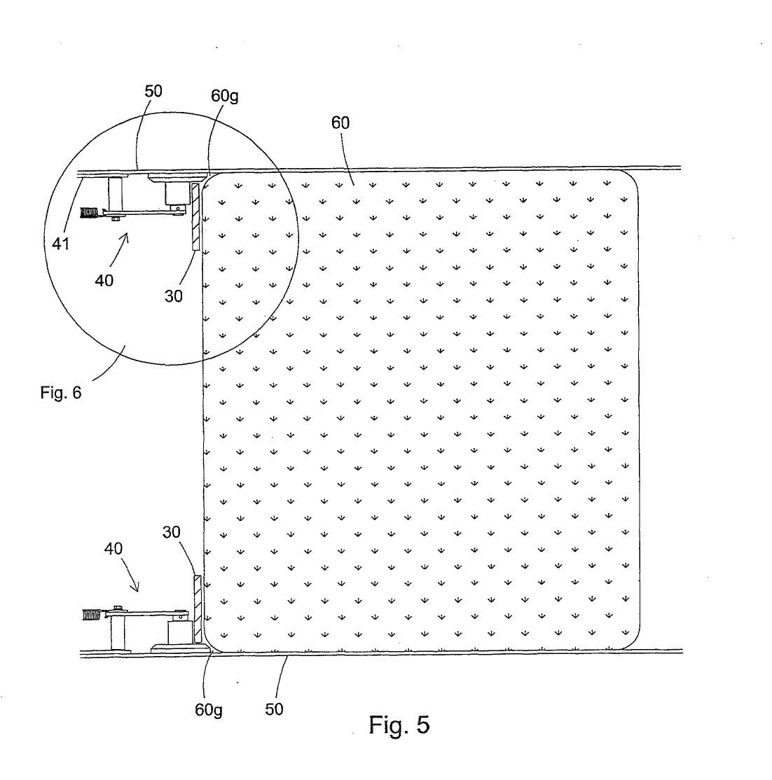

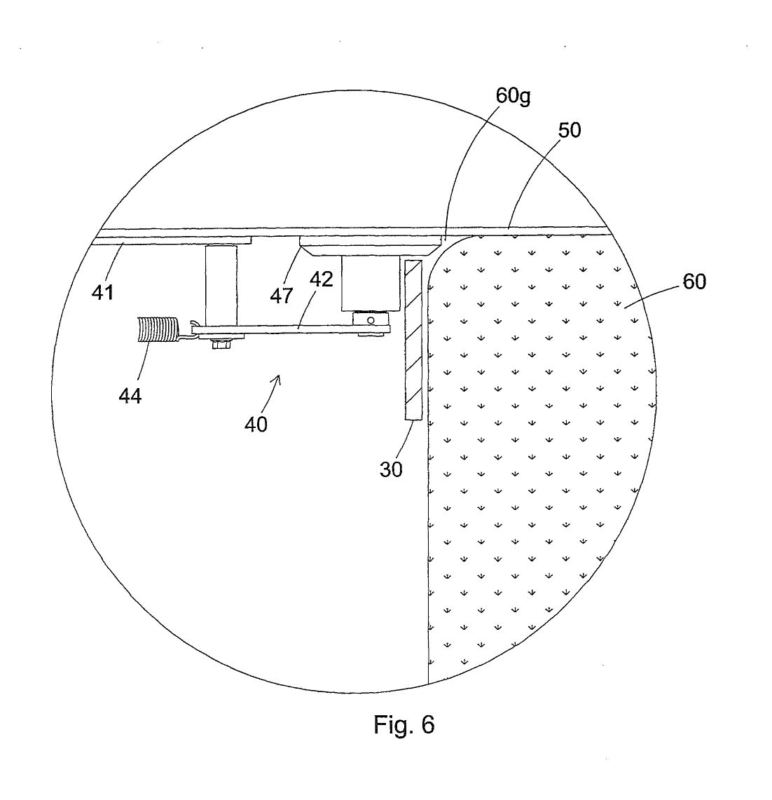

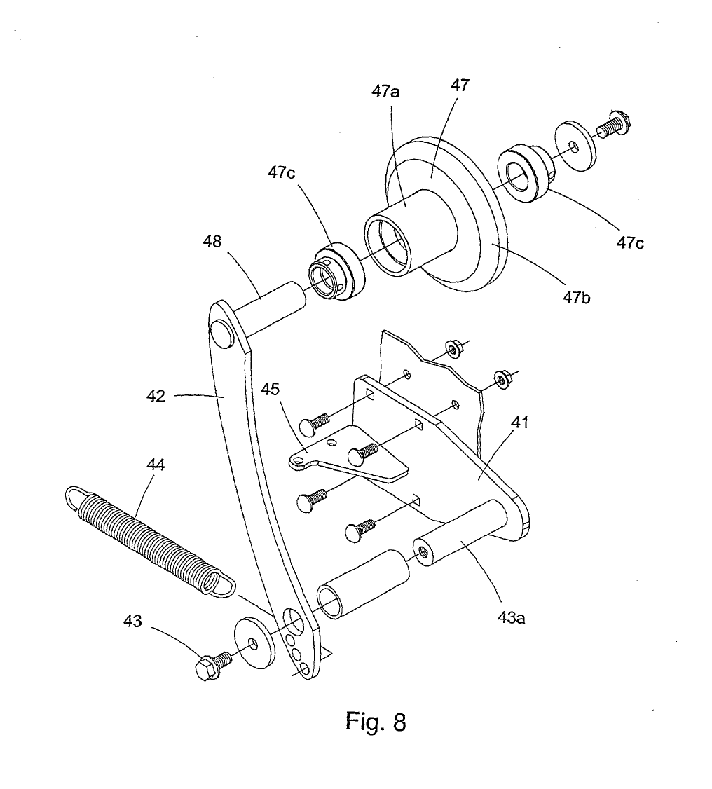

The rotatable disc/bale edge engaging member assembly 40 is shown in more detail in FIGS. 4-8. The basic parts of this rotatable disc/bale edge engaging member assembly 40 include a bale edge engaging member 41 bolted to the sidewall 50 as can be seen in FIG. 5. The bale edge engaging member 41 has an arm 42 pivotally attached about a pin 43/43a, the arm 42 being biased to the FIG. 1 position by a tension spring 44, best seen in FIG. 4. The spring is attached to the bale edge engaging member 41 at flange 45 at one end and to the arm 42 by attaching the other end of the spring 44 in one of three holes 46a, 46b or 46c in the arm 42 (FIG. 4), it being understood that the biasing force on the arm 42 can be changed by choosing the hole corresponding to the lever arm length desired, hole 46a providing the greatest pivoting force and hole 46c providing the least pivoting force from the spring. This invention is not, of course, limited to this specific way of adjusting the pivoting force on arm 44.

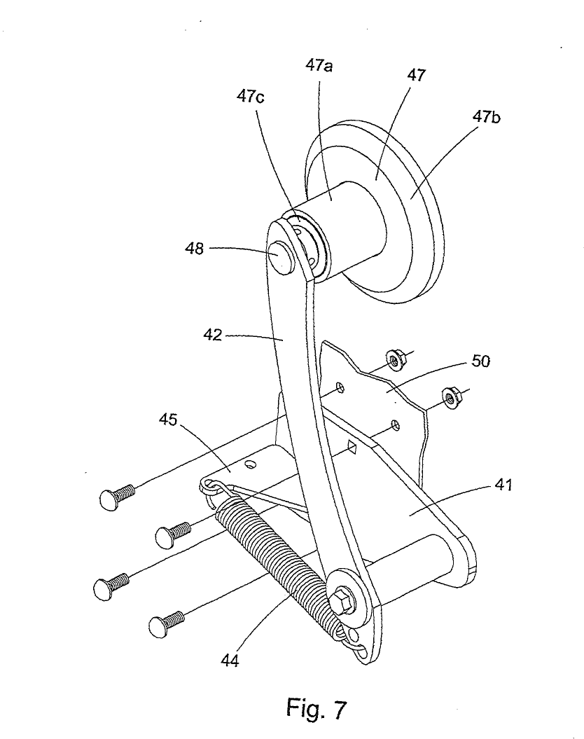

A rotatable bale edge engaging member/disc 47 is rotatably attached to the arm 42 about pin 48 as best seen in FIG. 4. A desired shape of the bale edge engaging member/disc 47 can be seen in FIG. 7 with a beveled portion 47b. A bearing 47c is disposed in sleeve portion 47a for example.

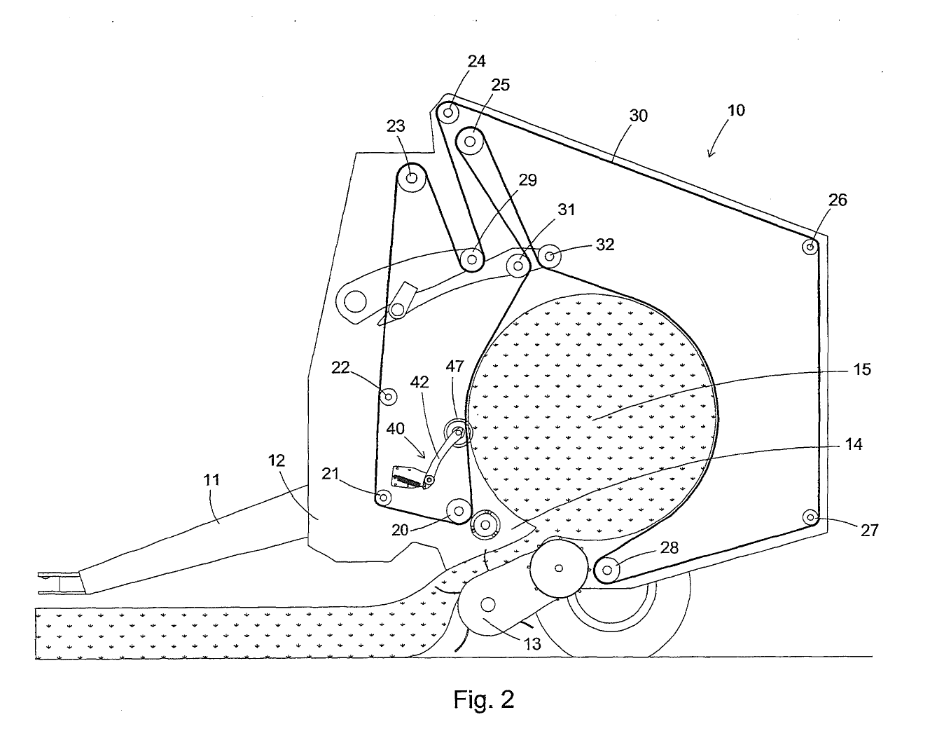

In operation, as a bale is being created as shown in FIGS. 2, 5 and 6 for example, some of the hay can come out between the belts and the sides 50 of the baler. The rotary hay wedge disc 47 is forced into the gap 60g between the outside belt 30 and the side wall 50 of the baler 10 by the force of the spring 44 and is allowed to rotate with the bale 60. It pushes into the bale throughout formation, either tucking the edges in or knocking the strands of hay off before the hay can get to an area that it causes problems. It starts just above the lower drive roller and rotates up as the bale grows larger and larger, for example as shown sequentially from FIG. 1 to FIG. 3.

When the bale 60 is completed and net wrap is being applied, the outside edges of the bale will have a shape that allows the net wrap to go over the edges more easily. The rotary hay wedge is also pushing against the net on the edges trying to tuck it around the corners better. This gives an improved aesthetic appearance.

This type of device could be used on any round baler both current production and even possibly retrofittable. The advantage that this provides is that it would eliminate potential down time from the problems that are caused by hay buildup.

The rotary disc could also serve as a guide for the outside belts to keep them from tracking outward as well. The rotary wedge is a larger diameter than the other rollers which helps prevent it from wrapping as easily with material. The idea behind it is that as the hay comes around from the lower tailgate area there is nothing preventing the hay from poking out between the outside belts and the side wall. This allows hay to stick out and then the next place it contacts is a “through the wall” drive roller on balers. In other words, when unwanted hay strands extend out between the belts and the side wall it becomes a problem because the unwanted hay strands rotate with the bale until that unwanted hay strand contacts one of the rollers that extends through the sidewall and those strands of hay can extend through those same openings in the side walls.

When this contact occurs the hay can get knocked off and then end up as buildup in the front of the baler. Certain conditions are worse for this and can cause major issues.

The device 40 could also be mounted off of the belt tightener or in the tailgate if desired. The preferred embodiment illustrated in FIGS. 1-3 have the device 40 located close to the lower drive roller. This is a vast improvement over the arrangement shown in Patent Application Publication U.S. 2001/0047640 to Schaefer, which is hereby incorporated by reference in its entirety, which shows discs 26 located where the pickup feeds the hay into the baling chamber.

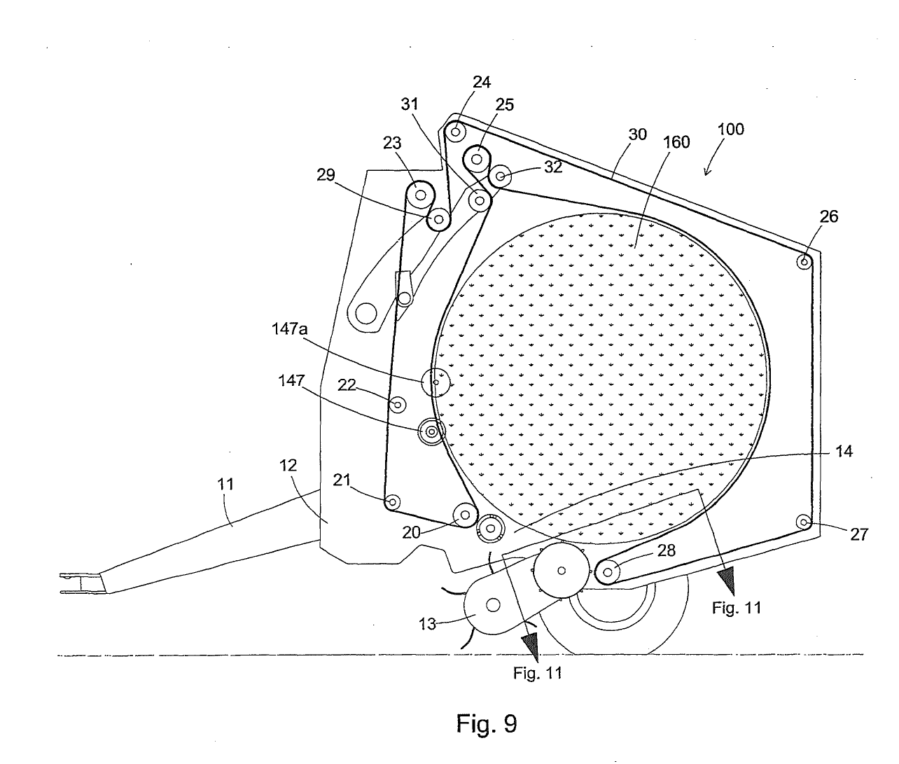

Alternate embodiments are shown in FIG. 9, which have a baler 100 with a bale edge engaging member/disc 147 in solid lines having a fixed axis of rotation that is parallel to the axes of rotation of the other rollers that the belts are trained around so that instead of following the bale from its infancy to its finished size, the rotatable bale edge engaging member/disc 147 in solid lines only tucks in the outer edges of the bale 160 during the final stages of the bale's formation.

FIG. 9 also shows another an alternate embodiment showing the rotatable bale edge engaging member/disc 147a in dashed lines having a fixed axis of rotation that is parallel to the axes of rotation of the other rollers that the belts 30 are trained around so that instead of following the bale 160 from its infancy to its finished size, the rotatable bale edge engaging member/disc 147a in dashed lines only tucks in the outer edges of the bale 160 during the final stages of the bale's formation, the difference between the embodiment shown in solid 147 and dashed lines 147a being that the axis of rotation of the one in solid lines 147 has the axis of rotation outside the baling chamber at all times and the embodiment shown in dashed lines 147a being that the axis of rotation of the one in dashed lines has the axis of rotation inside the baling chamber only during the final stages of formation of the bale 160.

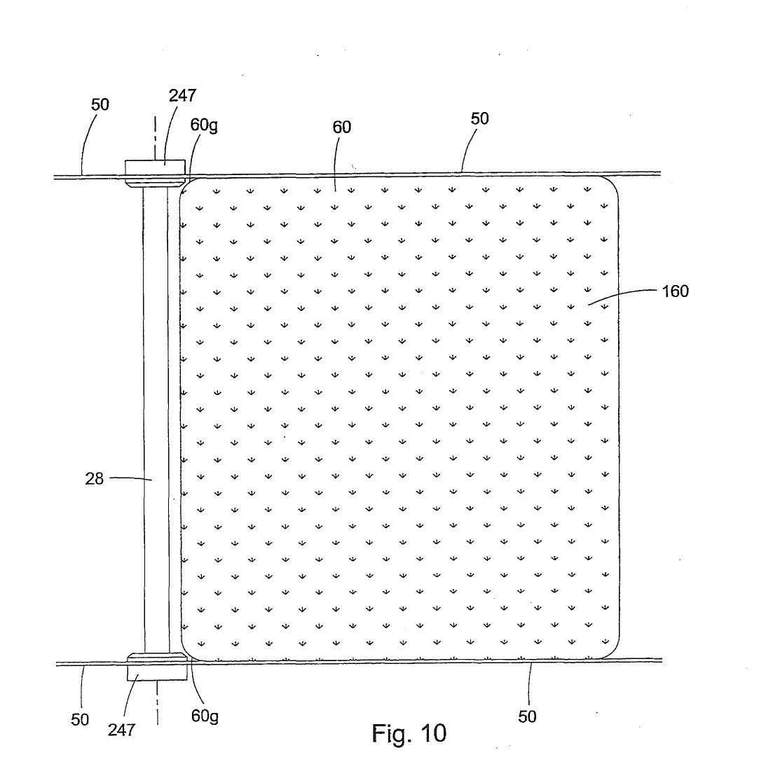

Looking now to FIG. 10, a top view of the baling chamber similar to FIG. 5 is shown, but showing bale edge engaging members 247 are arranged on a belt supporting roller 28, the bale edge engaging members 247 projecting through openings in the side walls 50 of the baler.

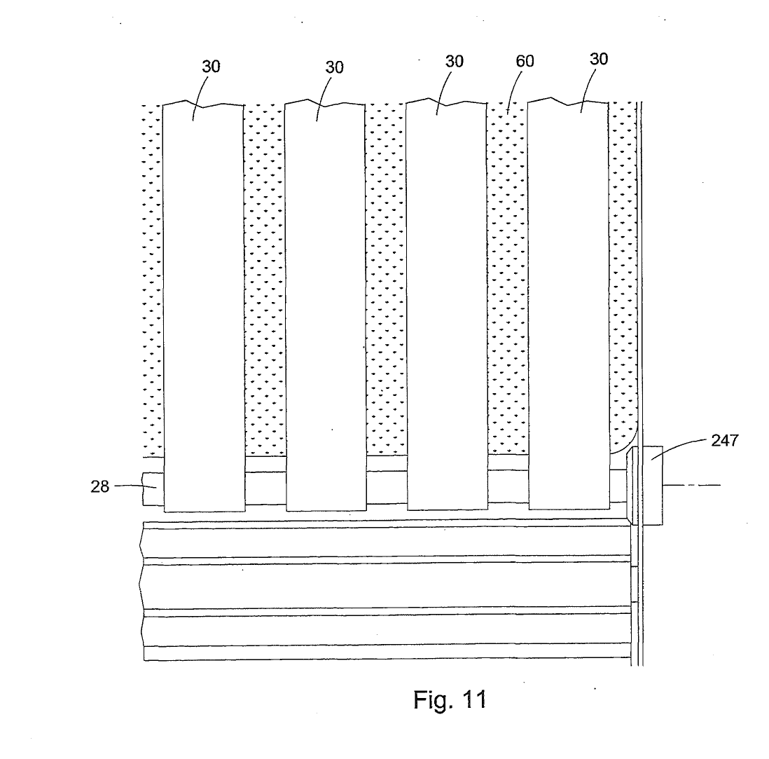

Referring to FIG. 11, a cross sectional view is shown taken along lines 11-11 of FIG. 9 showing the baler belts 30 trained over a roller 28 that has bale edge engaging members 247 attached through the sidewalls 50 of the baling chamber.

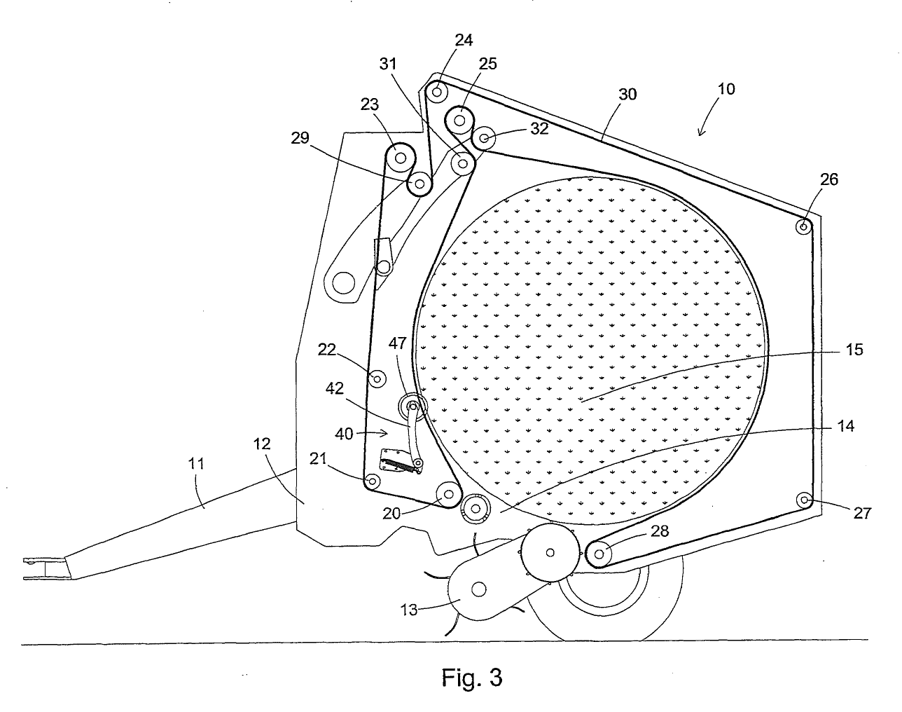

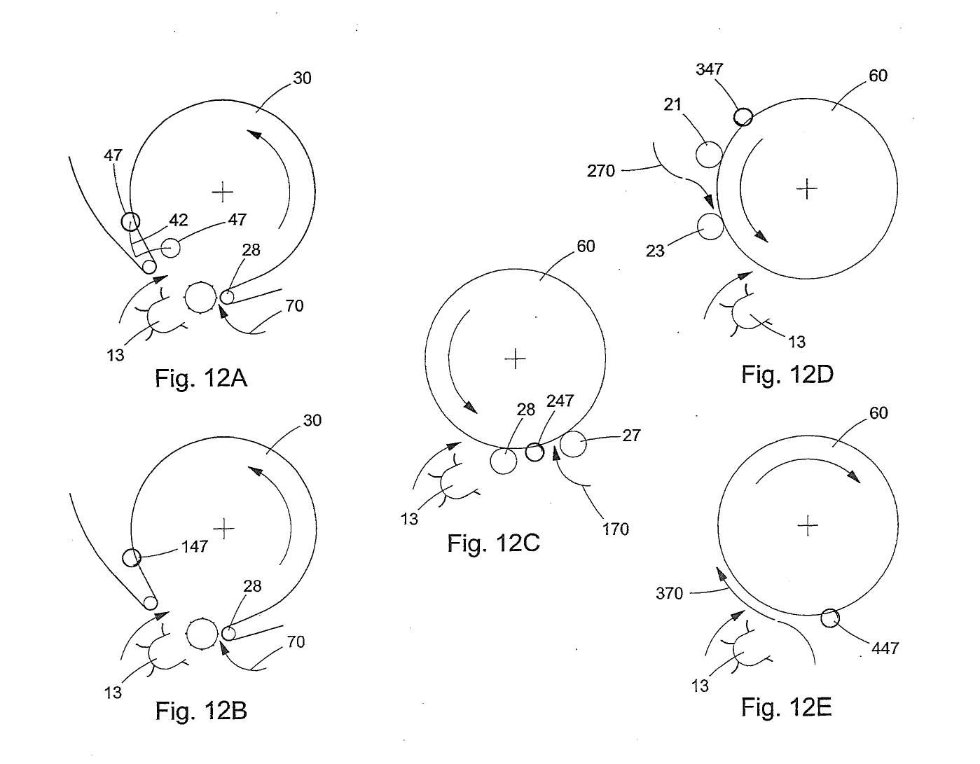

FIG. 12A is a side elevational schematic view showing the preferred embodiment of FIGS. 1-8 with a bale edge engaging member 47 shown in dashed lines in the position it would be in FIG. 2 and in a dark circle in the position it would be in FIG. 3 and furthermore showing netwrap entry point 70. While it is not essential for the invention in its broadest application, it can be important that the bale edge engaging members 47 be positioned as close as possible, seen in the direction of rotation of the bale, before the gap 70 or entry point of netwrap that would be placed around a completed bale 60.

Looking now to FIG. 12B, a side elevational schematic view like the preferred embodiment of FIG. 9 with a bale edge engaging member 147 and showing netwrap entry point 70 positioned as close as possible, seen in the direction of rotation of the bale, before the gap 70 or entry point of netwrap that would be placed around a completed bale 60.

FIG. 12C is a side elevational schematic view showing another preferred embodiment showing only two of several fixed position belt rollers 27 and 28 with a bale edge engaging member 247 disposed between them and furthermore showing netwrap entry point 170 so that netwrap entry point 170 is positioned as close as possible, seen in the direction of rotation of the bale, before the gap 170 or entry point of netwrap that would be placed around a completed bale 60.

Referring now to FIG. 12D, a side elevational schematic view shows still another preferred embodiment illustrated with only two of several fixed position belt rollers 21 and 23 with a bale edge engaging member 347 disposed before them and furthermore showing netwrap entry point 270.

Finally, FIG. 12E is a side elevational schematic view showing still another preferred embodiment of a baler rotating the crop in the baling chamber in the opposite direction of all of the other embodiments shown and with a bale edge engaging member 447 disposed before any of the rollers (not shown) and furthermore showing netwrap entry point 370 so that netwrap entry point 370 is positioned as close as possible, seen in the direction of rotation of the bale, before the gap 370 or entry point of netwrap that would be placed around a completed bale 60.

Further modifications in addition to those described above may be made to the structures and techniques described herein without departing from the spirit and scope of the invention. Accordingly, although specific embodiments have been described, these are examples only and are not limiting upon the scope of the invention.

What is claimed is:

1. A baler comprising:
a frame;
a baling chamber operatively attached to the frame for receiving a material to be baled, the bale forming chamber comprising a first and second side panel, a plurality of rotary members rotatably disposed respectively about parallel axes, more than one of the parallel axes being fixed with respect to the side panels,
the baler further comprising:
at least a first bale edge engaging member operatively rotatably attached to the frame about an axis of rotation substantially parallel to said axes of the rollers, said bale edge engaging member being disposed adjacent an inside portion of one of the side panels in overlapping arrangement with a bale being formed in the baling chamber at least at times when a bale is being formed therein,
wherein the baler comprises a material to be baled pickup to deliver material to be baled to an inlet of the bale forming chamber, and wherein said bale edge engaging member is spaced from the inlet to the bale forming chamber so as to not impede material entering the bale forming chamber from the material to be baled pickup.

2. The baler of claim 1, wherein the axis of rotation of the bale edge engaging member is at all times disposed outside of the bale forming chamber.

3. The baler of claim 1, comprising a second bale edge engaging member operatively rotatably attached to the frame about an axis of rotation substantially parallel to said axes of the rollers, the second bale edge engaging member being disposed adjacent an inside portion of the other one of the side panels in overlapping arrangement with the bale being formed, a portion of the second bale edge engaging member extending into the bale forming chamber at least at times when the bale is being formed therein.

4. The baler of claim 3, wherein the axis of rotation of the second bale edge engaging member is aligned with the axis of rotation of the first said bale edge engaging member.

5. The baler of claim 1, including a support arm operatively pivotally attached to the frame about an axis parallel to the axis of rotation of the bale edge engaging member and the bale edge engaging member being operatively rotatably attached to the support arm.

6. The baler of claim 5, wherein a portion of the support arm having the bale edge engaging member thereon is moveable between a first, inner, position when the bale formation belt is being used during first stages of formation of a round bale and a second, outer, position when the bale formation belt is being used during final stages of formation of a round bale.

7. The baler of claim 5, wherein the support arm is operatively biased towards the bale, in particular by a spring that is operatively attached to the support arm for biasing the support arm to the first, inner, position thereof.

8. The baler of claim 5, including a second support arm operatively pivotally attached to the frame about an axis parallel to the axis of rotation of the second bale edge engaging member and the second bale edge engaging member being operatively rotatably attached to the second support arm.

9. The baler of claim 8, wherein a portion of the second support arm having the second bale edge engaging member is moveable between a first, inner, position during first stages of formation of a round bale and a second, outer, position during final stages of formation of the round bale.

10. The baler of claim 9, wherein the second support arm is operatively biased towards the bale by a second spring that is operatively attached to the second support arm for biasing the second support arm to the first, inner, position thereof.

11. The baler of claim 1, wherein the baling chamber has a gap for introduction of net wrap and wherein the rotary members operatively rotate the bale being formed in one rotary direction and wherein the member contacts a portion of the bale being formed prior to said portion entering the gap where the net wrap enters the baling chamber.

12. The baler of claim 11, wherein the bale edge engaging member is located as close as possible before the gap for introduction of net wrap.

13. The baler of claim 11, wherein the baling chamber has a gap for introduction of net wrap and wherein the rotary members operatively rotate the bale being formed in one rotary direction and wherein the bale edge engaging member contacts a portion of the bale being formed prior to said portion entering the gap where the net wrap enters the baling chamber.

14. The baler of claim 13, wherein the bale edge engaging member is located as close as possible before the gap for introduction of net wrap taking into account the direction of rotation of the bale being formed in the baling chamber.

15. A baler comprising:
a frame;
a baling chamber operatively attached to the frame for receiving a material to be baled, the bale forming chamber comprising a first and second side panel, a plurality of rotary members rotatably disposed respectively about parallel axes, more than one of the parallel axes being fixed with respect to the side panels,
wherein the baler further comprises a bale edge engaging member operatively rotatably attached to the frame about an axis of rotation substantially parallel to said axes of the rollers, the bale edge engaging member being disposed adjacent an inside portion of one of the side panels in overlapping arrangement with a bale being formed in the baling chamber at least at times when a bale is being formed therein; and
a support arm operatively pivotally attached to the frame about an axis parallel to the axis of rotation of the bale edge engaging member and the bale edge engaging member being operatively rotatably attached to the support arm.

16. The baler of claim 15, wherein a portion of the support arm having the bale edge engaging member thereon is moveable between a first, inner, position when the bale formation belt is being used during first stages of formation of a round bale and a second, outer, position when the bale formation belt is being used during final stages of formation of a round bale.

17. The baler of claim 15, wherein the support arm is operatively biased towards the bale.

18. The baler claim 15, wherein the axis of rotation of the bale edge engaging member is at all times disposed outside of the bale forming chamber.

19. The baler of claim 15, wherein the baling chamber has a gap for introduction of net wrap and wherein the rotary members operatively rotate the bale being formed in one rotary direction and wherein the member contacts a portion of the bale being formed prior to said portion entering the gap where the net wrap enters the baling chamber, wherein the bale edge engaging member is located as close as possible before the gap for introduction of net wrap.

20. The baler of claim 15, wherein the baling chamber has a gap for introduction of net wrap and wherein the rotary members operatively rotate the bale being formed in one rotary direction and wherein the bale edge engaging member contacts a portion of the bale being formed prior to said portion entering the gap where the net wrap enters the baling chamber, wherein the bale edge engaging member is located as close as possible before the gap for introduction of net wrap taking into account the direction of rotation of the bale being formed in the baling chamber.
